(19) United States
(12) Patent Application Publication
(10) Pub. No.: US 2026/0037410 A1
(43) Pub. Date: Feb. 5, 2026

(54) APPLICATION INSTRUMENTATION USING IN-BAND TELEMETRY

(71) Applicant: Hewlett Packard Enterprise Development LP, Spring, TX (US)

(72) Inventors: Gregg Bernard Lesartre, Fort Collins, CO (US); Anthony M. Ford, Bristol (GB); Duncan Roweth, Bristol (GB)

(21) Appl. No.: 18/791,105

(22) Filed: Jul. 31, 2024

(51) Int. Cl. G06F 11/36; G06F 11/30; G06F 11/34; H04L 69/22

(52) U.S. Cl. CPC G06F 11/3644; G06F 11/302; G06F 11/3466; H04L 69/22; G06F 2201/865

(57) ABSTRACT

One aspect of the disclosure can provide a method and system for application instrumentation. During operation, a node within a network may identify an application packet to be inserted with telemetry metadata, determine an execution phase of an application associated with the identified application packet, and insert application-specific telemetry metadata into an In-band Network Telemetry (INT) header of the identified application packet, the INT header comprising one or more metadata header fields and one or more metadata fields. The node may further insert at least one marker into the one or more metadata header fields, the marker indicating the determined execution phase of the application.

### STATEMENT OF GOVERNMENT-FUNDING CLAUSE

This invention was made with Government support under Contract Number H98230-15-D-0022/0003 awarded by the Maryland Procurement Office. The Government has certain rights in this invention.

### BACKGROUND

### Field

This disclosure is generally related to monitoring the performance of applications. More specifically, this disclosure is related to linking in-band telemetry (INT) metadata with the execution stages of the applications.

### Related Art

Telemetry is commonly used to collect, analyze, and report data about the status, performance, and operation of a network. A telemetry process involves gathering detailed information from network devices and traffic flows, which is used for monitoring, troubleshooting, optimizing, and securing the network.

Successful execution of user applications often relies on the successful transportation of data across a network (e.g., between a sender node and a receiver node). Thus, application performance is usually related to the performance of the network through which the data traverses. However, there is often a disconnect between network telemetry data and user applications. More particularly, views of application execution and system activity presented to users are often disjoint, without a common point of reference other than an approximate time.

The lack of association between the network telemetry data and the application execution makes it difficult to evaluate accurately the state of an application running over shared network data paths. In the case of poor performance, it may be difficult to determine whether the application or network could be further optimized, or whether the network has reached its capacity. It can also be a challenge to determine how the network behavior influences the critical path of the application, and to identify causes for poor performance. This lack of understanding may lead to uncertainty in site capacity planning and system provisioning. An over-provisioned network may guarantee capacity but could result in reduced margins and lost profits. On the other hand, an under-provisioned network may limit application performance and failure to meet service level agreements. Moreover, the lack of knowledge of the relationship between application execution and the network performance may prevent the application developers in identifying application phases that are affected more heavily by network performance. Such knowledge may be used by developers to improve the application performance.

### BRIEF DESCRIPTION OF THE FIGURES

FIG. 1 illustrates the block diagram of an example system implementing In-band Network Telemetry (INT)-based application-performance monitoring, according to one aspect of the instant application.

FIG. 2A illustrates an example format of In-band Network Telemetry (INT) headers, according to one aspect of the instant application.

FIG. 2B illustrates an example format of INT metadata header 206, according to one aspect of the instant application.

FIG. 3 presents a diagram illustrating an example of the usage model hierarchy, according to one aspect of the instant application.

FIG. 4 presents a flowchart illustrating an example application instrumentation process, according to one aspect of the instant application.

FIG. 5 illustrates a computer system for facilitating the application instrumentation, according to one aspect of the instant application.

FIG. 6 illustrates a computer-readable medium 600 which facilitates INT-based application instrumentation, according to one aspect of the instant application.

In the figures, like reference numerals refer to the same figure elements.

### DETAILED DESCRIPTION

High-performance computing (HPC) applications may be running on a large number of nodes (e.g., computing devices), and application data is often exchanged among those nodes during the execution of the applications. For performance monitoring or debugging purposes, it may be desirable to correlate the execution phases of a particular application with network telemetry information as the application data (e.g., in the form of packets) traverses the network.

Application instrumentation (e.g., a process of adding code to an application) has been used to collect data about the applications' performance, behavior, and resource usage. Application instrumentation is not (and often cannot be) aware of the network devices that the application packets traverse. On the other hand, network telemetry data (e.g., network devices traversed, ingress and egress ports, ingress and egress timestamps, queue/buffer depths, routing and forwarding decision information, local and/or aggregate latency, etc.) gathered for packets traversing a network is often aggregated over all applications using network elements and is not application specific.

Previous approaches may include implementing application-specific filters such that counter data can be selected using a single identifier assigned by the network interface card (NIC). Such telemetry data is retrieved in the network context at the system level and is not readily available to users. System-level correlation of application behavior and network device state can attempt to make associations across separately sampled telemetry data. However, it at best can result in coarsely grained, loosely coupled relationships due to the periodic sampling used to collect the network state. Sampling itself may prevent accurate correlations across the network due to event-time aliasing, where telemetry timestamps mark the time of sampling rather than when a network event occurred. This problem increases with the scale of the network, as a sample sweep duration takes many seconds, while network events occur at nanosecond frequencies, making it difficult to correlate related events across the network.

According to some aspects of the instant disclosure, the application-performance-monitoring system can use In-band Network Telemetry (INT) techniques to gather application-specific network statistics and counters. When application data packets traverse a network, each node may insert telemetry metadata (e.g., information associated with congestion metrics, per-hop latency, buffer utilization, etc.) into the headers of the packets. When a packet arrives at its destination, the INT header may be extracted, and a report may be created and written to a local management buffer to allow the user to see a trace of the network behavior over the application's runtime. Moreover, to correlate the network telemetry data with the execution phase of an application, additional application execution context may be added (e.g., via application instrumentation) to mark the execution progress of the application. The INT-based application instrumentation may provide a mechanism to gather and report network telemetry and performance data specifically related to an application's execution while the application is running without performance degradation. More specifically, the application instrumentation information may mark the application's execution phase, operational context, loop iteration, or the instruction or library call/return occurrence. According to some aspects, the application instrumentation information may be inserted into the INT header to provide associations between the application execution (e.g., phase, operational context, loop iteration, or the instruction or library call/return occurrence) and the collected network telemetry data. Such association information may allow application developers to gain insight into the execution of the application as it traverses a network in order to improve the performance of the application.

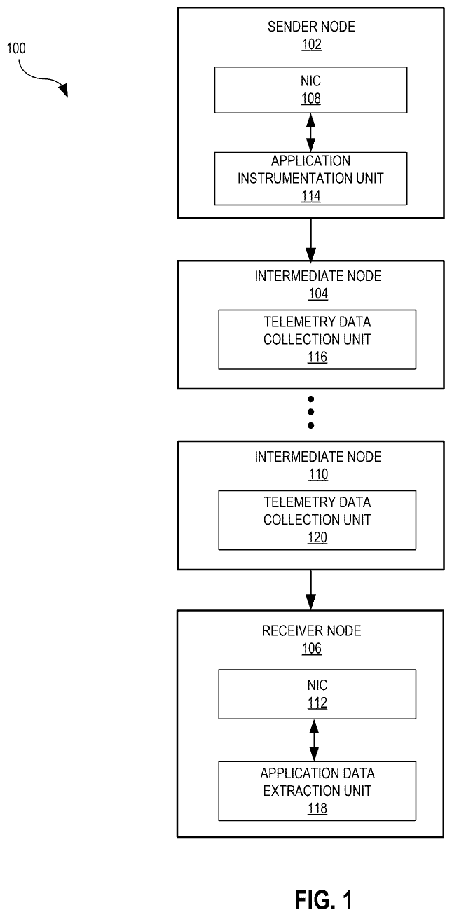

FIG. 1 illustrates the block diagram of an example system implementing In-band Network Telemetry (INT)-based application-performance monitoring, according to one aspect of the instant application. In the example shown in FIG. 1, an application-performance-monitoring system 100 may include a sender node 102, a plurality of intermediate nodes (e.g., intermediate nodes 104 and 110), and a receiver node 106. Sender node 102 is to send data packets associated with an application to received node 106 via the plurality of intermediate nodes (e.g., nodes 104 and 110). Each node is a computing device, which may be any single computing device, a set of computing devices, a portion of one or more computing devices, or any other physical, virtual, and/or logical grouping of computing resources. According to some aspects, a computing device is any device, portion of a device, or any set of devices capable of electronically processing instructions and may include, but is not limited to, any of the following: one or more processors (e.g., components that include circuitry) (not shown), memory (e.g., random access memory (RAM)) (not shown), input and output device(s) (not shown), non-volatile storage hardware (e.g., solid-state drives (SSDs), persistent memory (Pmem) devices, hard disk drives (HDDs) (not shown)), one or more physical interfaces (e.g., network ports, storage ports) (not shown), any number of other hardware components (not shown), and/or any combination thereof.

Examples of computing devices include, but are not limited to, a server (e.g., a blade-server in a blade-server chassis, a rack server in a rack, etc.), a desktop computer, a mobile device (e.g., laptop computer, smart phone, personal digital assistant, tablet computer, automobile computing system, and/or any other mobile computing device), a storage device (e.g., a disk drive array, a fiber channel storage device, an Internet Small Computer Systems Interface (ISCSI) storage device, a tape storage device, a flash storage array, a network attached storage device, etc.), a network device (e.g., switch, router, multi-layer switch, etc.), a virtual machine, a virtualized computing environment, a logical container (e.g., for one or more applications), an Internet of Things (IoT) device, an array of nodes of computing resources, a supercomputing device, a data center or any portion thereof, and/or any other type of computing device with the aforementioned requirements.

According to some aspects, the aforementioned nodes may be part of a set of any number of nodes that are configured to operate as a high-performance computing (HPC) environment. An HPC environment may include any number of nodes, which may be homogeneous or heterogenous in regards to device capabilities, and that provide a platform for executing HPC applications (e.g., Artificial Intelligence (AI), machine learning, deep learning, autonomous driving, product design and manufacturing, weather modeling and forecasting, seismic data analysis, financial risk assessment, fraud detection, computational fluid dynamics, DNA sequencing, contextual search algorithms, traffic management, complex simulations, drug research, virtual reality, augmented reality, etc.). HPC environments often provide a platform for executing application workloads that use large numbers of nodes to perform various portions of the application, and, as such, often transmit data to one another over a network (discussed further below).

In the example shown in FIG. 1, sender node 102 includes a NIC 108 for connecting sender node 102 to the network (e.g., the intermediate nodes), and receiver node 106 includes a NIC 112 for connecting receiver node 106 to the network. A NIC is an input and/or output component configured to provide an interface between a node and a network and is used to receive and/or transmit communication packets. A communication packet typically includes a payload (e.g., data intended for consumption by an entity receiving the packet) and a number of headers and/or trailers, which may include information intended to allow receiving entities to perform various actions to propagate the packet towards a destination (e.g., receiver node 106). Examples of the information may include, but are not limited to, various items of information related to protocols being used for implementing data transmission (e.g., media access control (MAC), internet protocol (IP), transmission control protocol (TCP), user datagram protocol (UDP), address resolution protocol (ARP), hypertext transfer protocol (HTTP), file transfer protocol (FTP), virtual extensible local area network (VXLAN) protocol, multiprotocol label switching (MPLS) segment routing (SR) protocols, etc.), addresses and/or labels related to such protocols (e.g., IP addresses, MAC addresses, label stacks, etc.), information related to error identification and/or correction, etc. A NIC (e.g., NIC 108 or 112) may be configured with interfaces of any type for receiving and/or transmitting communication packets, such as, for example, wireless interfaces, wired interfaces, etc. Although FIG. 1 shows a node as including a single NIC, the computing device may include any number of NICs.

A NIC (e.g., NIC 108 or 112) may be a Smart NIC that includes additional processing resources relative to a standard NIC. A SmartNIC may include various hardware components, subsystems, etc. configured to perform processing on received packets to offload at least some of such processing from one or more processors of a computing device. Such hardware components may include, but are not limited to, field programmable gate arrays (FPGAs), systems on a chip (SOCs), digital signal processors (DSPs), etc. Such hardware components may be, or be included in, one or more subsystems (e.g., a RISC-ARM subsystem) of a SmartNIC.

According to some aspects, a NIC (e.g., NIC 108 or 112) may be configured to identify a packet using a match-action rule and perform an action specified by the rule. The match operation may be performed using any information included in and/or associated with a packet received at the NIC. In some examples, a corresponding action based on such a match may include inserting telemetry metadata into the packet, stripping telemetry metadata from a packet, etc. The telemetry metadata may include information associated with various network characteristics (e.g., latency, throughput, congestion metrics, etc.) and application-specific context information. Examples of application-specific context information may include information identifying the application and information identifying a portion of the application causing the packet to be sent (e.g., process, application phase, application stage, application function, application operation, etc.).

In the example shown in FIG. 1, sender node 102 may include an application instrumentation unit 114, which is configured to instrument the application, causing application-execution context (also referred to as the application-instrumentation information) to be inserted into the INT header fields within the packet. According to some aspects, the application-instrumentation information may be in the form of specially designed markers inserted into the INT header fields. Examples of the markers may include application-specific opcodes, indices, identifiers of commands or library calls, or free text. The markers may include high-level information, such as a label indicating the phase of execution or the cycle number within an iterative process, as well as low-level information, such as identifiers of communication library calls (e.g., a Message Passing Interface (MPI) function). For example, the execution of an application may include a predetermined number of phases (e.g., five phases), and the marker may be a numeric value (e.g., a number ranging from one to five), indicating the current execution phase of the application. Although FIG. 1 shows application instrumentation unit 112 as a standalone unit separate from NIC 108, there can be various implementations that may involve different software and hardware components within sender node 102 or NIC 108 for instrumenting the application. In some examples, application instrumentation unit 112 may be part of NIC 108.

The intermediate nodes are responsible for forwarding the packets toward the destination. Examples of the intermediate nodes include but not limited to: switches, routers, repeaters, hubs, gateways, bridges, etc. Each intermediate node may include a telemetry data collection unit configured to collect per-hop telemetry data. In this example, intermediate node 104 includes a telemetry data collection unit 116, and intermediate node 110 includes a telemetry data collection unit 120. According to some aspects, each node may be configured to gather Control and Status Register (CSR) values according to a profile or template selected from a set of predetermined (or pre-configured) INT profiles or templates. In one example, there may be eight INT profiles or templates, with each profile or template specifying a set of CSRs and network characteristics (e.g., latency, throughput, congestion metrics, etc.) to be collected at each node. For example, the template or profile identifier may be used by NIC 110 to update fields in the INT metadata based on the specified CSR values and software-updated scrape buffers as the packets traverse the network. According to some aspects, a template or profile identifier may be part of the markers inserted into the INT header fields at sender node 102. According to further aspects, as an application progresses through the different execution phases, the template or profile identifier inserted into the INT header fields may be modified to allow different network characteristics to be collected at different application execution phases.

Examples of the per-hop telemetry data may include any of the standard INT-based telemetry data (e.g., ingress/egress interface, latency information, routing and forwarding decision information, buffer and queue depths, etc.), as well as any optional information (e.g., device register states, counter information, etc.) that is particular to the node as it receives, processes and/or transmits the packet.

Receiver node 106 may include an application data extraction unit 118 configured to extract the per-hop telemetry data along with the application-execution context from the INT header fields within the packet. In one example, application data extraction unit 118 may also generate a report that includes both the network telemetry information and the application-specific telemetry information associated with the data flow to which the packet belongs. The INT report may be delivered to the application space, being written to a locally managed buffer where the reports are available to the user. For example, the INT report may be used to render real-time information about the application execution in a user interface to be viewed by a user of the application. In another example, the INT report may be provided to a remote server configured to receive telemetry metadata specific to the application, which may be further configured to perform analysis on the aggregated telemetry metadata of the application.

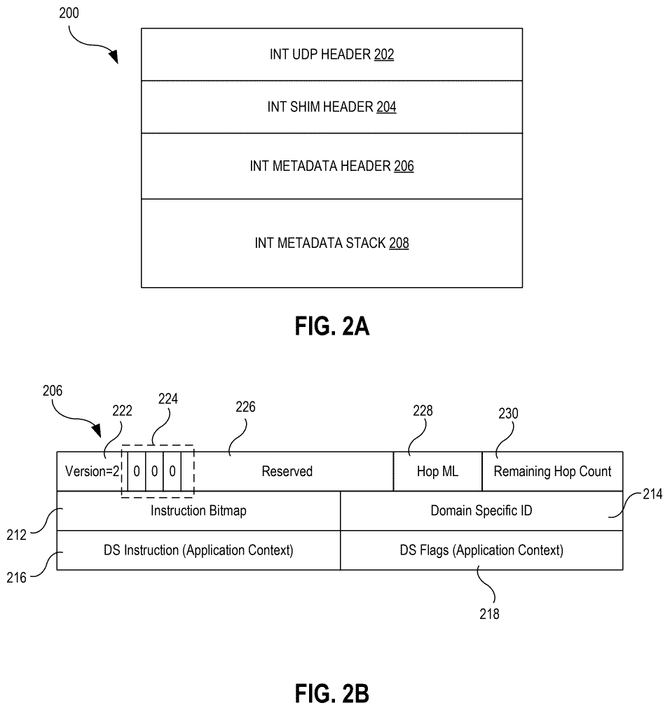

FIG. 2A illustrates an example format of In-band Network Telemetry (INT) headers, according to one aspect of the instant application. In FIG. 2A, the INT headers are shown in an embedded format (i.e., INT-MD), wherein INT instructions and metadata are written into the packet (e.g., as part of the packet payload). Moreover, in this example, it is assumed that INT headers 200 are part of the User Datagram Protocol (UDP) payload.

In the example shown in FIG. 2A, INT headers 200 includes an INT UDP header 202, an INT shim header 204, an INT metadata header 206, and an INT metadata stack 208. INT UDP header 202 typically may include standard UDP header fields, and INT shim header 204 may be used to create an encapsulation. INT UDP header 202 and INT shim header 204 may be similar to those defined in the INT standard.

FIG. 2B illustrates an example format of INT metadata header 206, according to one aspect of the instant application. INT metadata header 206 may include 12 bytes, with the first four bytes including a 4-bit version field 222, three 1-bit flags 224 (e.g., a D flag indicating whether the packet should be discarded after extracting the INT data, an E flag indicating max hop count exceeded, and an M flag indicating maximum transmission unit (MTU) exceeded), a 12-bit reserved field 226, a 5-bit per-hop metadata length (Hop ML) field 228, and an 8-bit remaining hop count field 230.

INT metadata header 206 may also include a 16-bit instruction bitmap field 212, with the first 14 bits representing baseline INT instructions (e.g., switch ID, ingress and egress port ID, hop latency, ingress and egress timestamps, etc.). INT metadata header 206 may include a 16-bit domain specific ID field 214, indicating the unique ID of the INT domain. Note that an INT domain comprises a set of inter-connected INT devices under the same administration. It is assumed that the INT devices within the same domain are configured in a consistent way to ensure interoperability between the devices.

INT metadata header 206 may include a 16-bit domain-specific (DS) instruction field 216 and a 16-bit DS flags field 218. According to the INT standard, the DS instruction is an instruction that requires additional processing of the DS flags. According to some aspects of the instant application, the application-instrumentation information (e.g., markers used to mark the application's execution phase, operational context, loop iteration, or the instruction or library call/return occurrence) indicating the execution stage of the application may be inserted into DS instruction field 216 and/or DS flags field 218. In one example, markers indicating the major execution phase of the application may be inserted into DS instruction field 216. In another example, markers specific to a particular execution phase (e.g., minor sub-phase sequence or iteration count) may be inserted into DS flags field 218. In some examples, an INT template or profile identifier may be inserted into DS instruction field 216, causing a predetermined set of CSR values to be collected at each hop.

There may be various mechanisms to implement the application instrumentation. According to some aspects, a hierarchy of usage modes may be provided, with lower-level models requiring none or little change to the application software and higher-level models providing greater user control and flexibility in correlating INT metadata with application execution phases.

The underlying mechanism for inserting the instrumentation (e.g., markers) and the INT metadata may be the same for all usage models. However, the different usage models rely on different components within the network device (e.g., server node 102) or different components within the NIC (e.g., NIC 108) to insert the markers into the DS instruction and/or DS flag fields (e.g., fields 216 and 218 shown in FIG. 2B) in the INT metadata header. Each usage model may provide a certain level of instrumentation, which can correlate application/service type, operation, behavior, or execution phase/stage with the INT metadata and the programmable scape data gathered as the application packets traverse the network, hop-by-hop between the data source (e.g., an entity sending the application packets in sender node 102) and the destination (e.g., an entity receiving the application packets in receiver node 106).

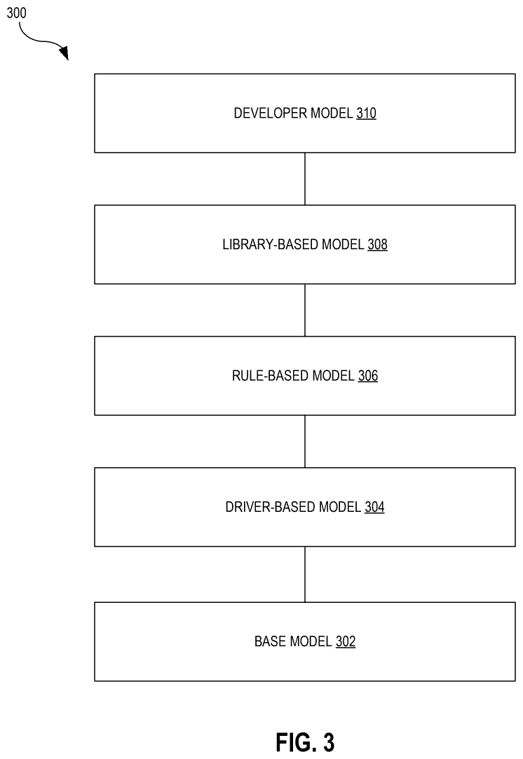

FIG. 3 presents a diagram illustrating an example of the usage model hierarchy, according to one aspect of the instant application. A usage model hierarchy 300 may include a base model 302, a driver-based model 304, a rule-based model 306, a library-based model 308, and a developer model 310. Base model 302 is the lowest-level usage model and does not require specific application instrumentation. When the base model is implemented, a profile or template identifier representing a predetermined set of CSR values may be inserted into the DS instruction field of the INT header. The profile is selected from a plurality (e.g., eight) of preconfigured profiles. According to some aspects, the selected profile may be specified as part of the DevOps network-wide management configuration. The profile ID in the DS instruction field may cause each node to collect the predetermined set of CSR values as the application packets traverse the network.

Driver-based model 304 is second-level usage model and relies on device drivers to insert the markers associated with the user, process, or job. Examples of the markers may include but are not limited to user and process IDs, job labels, and other attributes of the application/service available through the device driver. According to some aspects, the markers may be configured as part of the device driver initialization through the system configuration files as a system-level DevOps configuration. Like in the base model, the CSR profile ID may be inserted into the DS instruction field of the INT metadata header. This driver-based usage model does not require changes in the user-level application software. However, if sufficient privilege is granted, the configuration of the network device may be modified through device driver system-level runtime files or a runtime device-level API. In another example, Peripheral Component Interconnect Express (PCIe) logic may insert the marker based on a virtual machine identifier or virtual function identifier, which is usually used by the PCIe logic for identifying traffic passing from a host CPU/GPU to a NIC.

Rule-based model 306 is the third-level usage model, in which match-action rules may be configured in the network device's match-action packet pipeline, resulting in actions to determine which network metrics and CSR values are gathered at each hop. According to some aspects, the match may be performed based on any one or more portions of any headers or fields of a packet, such as, for example, layer 2 (L2), L3, and/or L4 fields, which may include, but are not limited to, source and destination Internet Protocol (IP) addresses, source and destination Media Access Control (MAC) addresses, source and destination port numbers (e.g., Transmission Control Protocol (TCP) and/or Universal Datagram Protocol (UDP) port numbers), virtual local area network (VLAN) tags, virtual network identifiers (VNIs), flow labels, differentiated services code point (DSCP) values, packet protocol, QoS class, etc. Moreover, transport-specific fields from the packet's transport headers, such as Ultra Ethernet Consortium (UEC) or RDMA over Converged Ethernet (RoCE) headers, may also be used in the match-action rule, so are the MPI tags or other contained fields in the transport headers. The match result (i.e., the action) may specify the CSR profile to use in the hop-by-hop metadata collection and the markers to be inserted in the DS instruction field and the DS flags field. With this rule-based usage model, changes in the user-level application software are not always required but may be available. In some examples, the match-action rules may be created as part of the system-level DevOps configuration. In alternative examples, if sufficient privilege is granted, the match-action rules may be created by the application or service launcher or by the user through a user-level API as part of the packet pipeline configuration.

Library-based model 308 is the fourth-level usage model and may rely on communication libraries linked with the application/service to create a runtime executable carrying detailed instrumentation within the library function calls (e.g., MPI calls). According to some aspects, a separate library can be created, which mirrors the function of the standard base library and carries additional API calls to insert call-specific markers into the gathered metadata. For example, additional API calls may be used to insert the library call ID into the DS instruction or DS flags field. According to alternative aspects, such instrumentation (i.e., the additional API calls) may be directly inserted into the standard base library, and additional functionality can be enabled through conditional paths of execution to include or exclude instrumentation. With this library-based usage model, changes in the user-level application software are required (either by creating a separate library or by modifying the standard base library). Moreover, it requires either relinking the application or service codes during the compilation of the executable in order to use the instrumented version of the library (i.e., the separately created library) or setting an environment variable or make an application API call to include the instrumentation in the modified base library.

Developer-level model 310 is the highest-level usage model and can provide the greatest instrumentation flexibility, in which instrumentation API calls may be inserted by application developers directly into the application or service codes. Such API calls may result in customized markers being inserted into the gathered metadata. In addition to the flexibility, this usage model also provided the highest level of correlation between the application behavior and the gathered metadata. The developer-level usage model may be used during the development of the application or service to understand the behavior, operation, and/or anomalies with the highest application-to-metadata resolution. Examples of the markers may include opcodes, indices, command or library call IDs, and free text. According to some aspects, the markers may include major phase markers indicating the major operational phases of the application execution. Depending on the use case, these major phase markers may include simple numerical values (e.g., numbers one to five) or free text (e.g., instruction or library call/return occurrence, joining or leaving a barrier, etc.). These major phase markers may be inserted into the DS instruction field. The markers may also include phase-specific markers such as minor sub-phase sequence numbers or iteration counts. These phase-specific markers may be inserted into the DS flags field. The developer-level usage model requires changes in the application codes or library to include the instrumentation API calls.

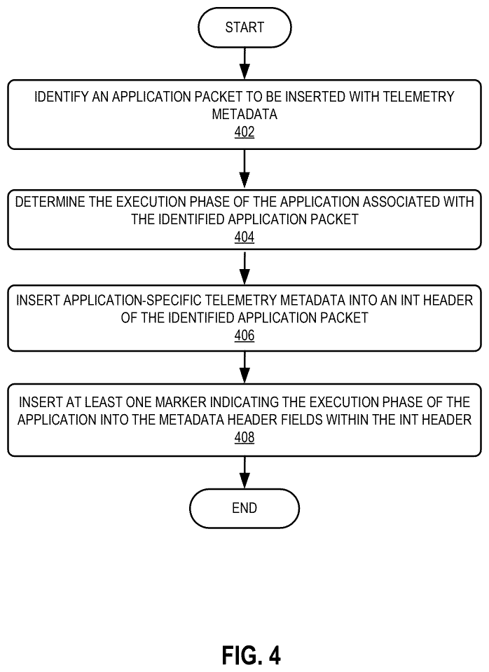

FIG. 4 presents a flowchart illustrating an example application instrumentation process, according to one aspect of the instant application. All or any portion of the operations shown in FIG. 4 may be performed, for example, by a device or set of devices (e.g., nodes 102-106 or NICs 108-112 shown in FIG. 1). Although the example process in FIG. 4 shows a specific order of performing certain operations, the process is not limited to such an order. Operations shown in succession in the flowchart may be performed in a different order and may be executed concurrently or with partial concurrence or combinations thereof.

During operation, the sender node associated with an application may identify an application packet to be inserted with telemetry metadata (operation 402). According to some aspects, the NIC of the sender node may apply a predetermined match rule to identify the application packet based on header information associated with the packet. The header information may include but is not limited to: L2, L3, and/or L4 fields, VLAN tags, Virtual Network Identifiers (VNIs), flow labels, differentiated services code point (DSCP) values, application identifiers, flow identifiers, flow labels, protocol information, etc.

The sender node may determine the execution phase of the application associated with the application packet (operation 404). For example, the sender node may determine an application phase (e.g., a data collection phase or a data processing phase) during which the application packet is generated. Depending on practical scenarios, the execution phases may be represented using a set of predetermined numerical values or text descriptions defined by the application developer. For example, the execution of an application may include a plurality of major phases, labeled as phase one to phase five. Moreover, each execution phase may include a plurality of minor sub-phases, such as performing a particular function call or executing a particular iteration. The logic unit within the sender node generating the application packet for transmission may determine the execution phase of the application.

The sender node may insert application-specific telemetry metadata into a header of the identified packet (operation 406). According to some aspects, the header may be an In-band Network Telemetry (INT) header (e.g., headers 200 shown in FIG. 2A) comprising a plurality of INT metadata header fields and one or more INT metadata fields. More specifically, the INT metadata header fields may include a DS instruction field (e.g., field 216) and a DS flags field (e.g., field 218). The INT metadata fields may include an INT metadata stack (e.g., field 208). The application-specific telemetry data may include information specific to the application, including but not limited to information identifying the application and information identifying a portion of the application causing the packet to be sent. According to some aspects, NIC 108 of sender node 102 may include logic units that perform the insertion of the application-specific telemetry data.

In addition to the application-specific metadata, the sender node may insert general network telemetry metadata that are related to the operational status and performance of the network. The general network telemetry metadata may include standard INT telemetry information, such as device information, ingress and/or egress interface of the packet, latency information, queue arbitration parameters, ingress and egress timestamps, header translation information, link utilization information, link load and congestion indicators, various queue and buffer states, packet pipeline operations, packet transformations, virtual routing and forwarding (VRF) information, flow information, changes to the size of the network data unit, information about routing and forwarding decisions made, any other type of data included in optional scrape fields (e.g., state of device registers, statistics, counters, codes that indicate something about the application to a user, free text of any sort, etc.), information about reasons a packet may be blocked for a period of time, measurement information of type and/or degree of congestion, and/or any combination thereof. The general network telemetry data may be inserted into the INT metadata stack 208.

The sender node may further insert at least one marker indicating the execution phase of the application into the INT metadata header fields (operation 408). Examples of the marker include but are not limited to opcodes, indices, command or library call IDs, and free text. More specifically, the marker may be inserted into the DS instruction field 216 and/or the DS flags field 218. In one example, a major phase marker may be inserted into the DS instruction field 216, and a phase-specific marker (e.g., a sub-phase sequence number or an iteration count number) may be inserted into the DS flags field 218.

Various entities and mechanisms may be used to insert the markers. In one example, the markers may be inserted by a device driver executing on the sender node. In another example, the markers may be inserted by PCIe logic or logic units within the packet-processing pipeline performing the match-action operations. In yet another example, the markers may be inserted by instrumented library calls or by instrumentation codes (e.g., API calls) embedded in the application codes.

In addition to the markers that indicate the application execution phase, according to some aspects, a CSR profile ID may also be inserted into the DS instruction field 216. This allows the user to select one of a plurality (e.g., eight) of pre-configured INT profiles assigning specific groups of packet header fields to be collected as metadata, with each profile grouping sets of network characteristics, such as latency, throughput, congestion metrics, etc. For example, a particular INT profile may specify a set of CSR values to be collected at each hop.

Because the INT metadata headers (e.g., the DS instruction field 216 and the DS flags field 218) precede the telemetry metadata (which is included in INT metadata stack 208 shown in FIG. 2A), inserting the markers into the INT metadata headers may uniquely associate the per-hop metadata with the application execution phase. More specifically, when application data extraction unit 118 in receiver node 106 extracts the telemetry metadata, it may also extract the markers from the DS instruction and DS flags fields and associate the extracted markers with the telemetry metadata. For example, the telemetry metadata extracted from one packet may be labeled as “phase one” metadata, whereas the telemetry metadata extracted from another packet may be labeled as “phase two” metadata.

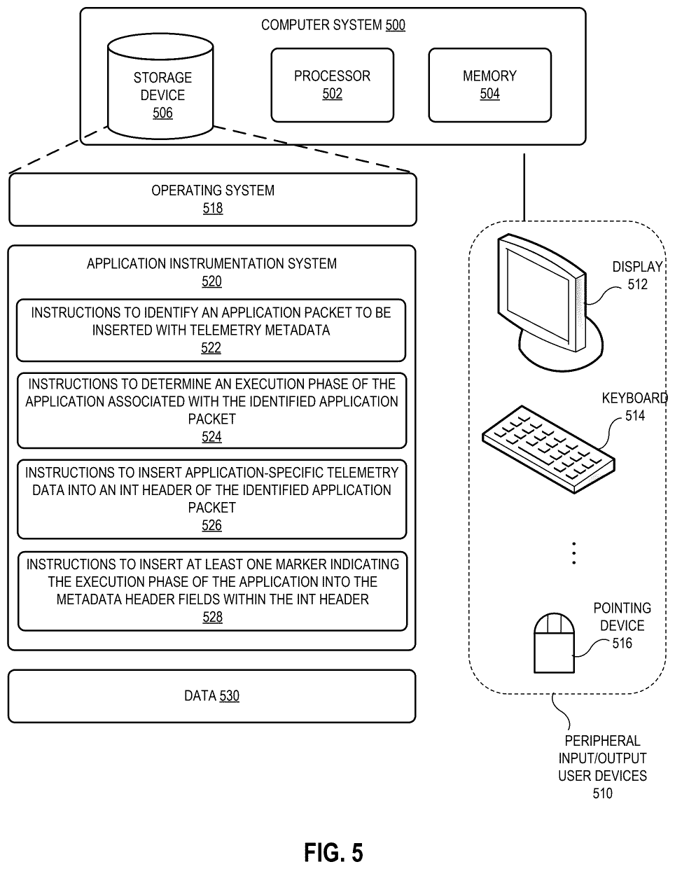

FIG. 5 illustrates a computer system for facilitating the application instrumentation, according to one aspect of the instant application. Computer system 500 includes a processor 502, a memory 504, and a storage device 506. Memory 504 may include a volatile memory (e.g., random access memory (RAM)) that serves as a managed memory and can be used to store one or more memory pools. Furthermore, computer system 500 may be coupled to peripheral I/O user devices 510 (e.g., a display device 512, a keyboard 514, and a pointing device 516). Storage device 506 includes a non-transitory computer-readable storage medium and stores an operating system 518, an application instrumentation system 520, and data 530. According to some aspects, computer system 500 may be implemented on a network device executing an application/service to send/receive application packets, such as sender node 102 shown in FIG. 1. Computer system 500 may include fewer or more entities or instructions than those shown in FIG. 5.

Application instrumentation system 520 may include instructions, which when executed by computer system 500, may cause computer system 500 to perform methods and/or processes described in this disclosure. Specifically, application instrumentation system 520 may include instructions 522 to identify an application packet to be inserted with INT telemetry metadata, as described above in relation to operation 402 shown in FIG. 4. According to some aspects, identifying the application packet may include applying a predetermined match rule to identify the application packet based on header information associated with the packet.

Application instrumentation system 520 may include instructions 524 to determine an execution phase of the application associated with the application packet, as described above in relation to operation 404 shown in FIG. 4. The execution of the application may include a plurality of major phases, with each execution phase including one or more minor sub-phases, such as performing a particular function call or executing a particular iteration.

Application instrumentation system 520 may include instructions 526 to insert application-specific telemetry metadata into a header of the identified application packet, as described above in relation to operation 406 shown in FIG. 4. The header may be an INT header, which may include a plurality of INT metadata header fields and an INT metadata stack. The application-specific telemetry data may include information specific to the application, including but not limited to information identifying the application and information identifying a portion of the application causing the packet to be sent. According to some aspects, the application-specific telemetry data may be inserted into the INT metadata stack.

Application instrumentation system 520 may include instructions 528 to insert at least one marker indicating the execution phase of the application into the INT metadata header fields, as described above in relation to operation 408 shown in FIG. 4. The markers may include but are not limited to opcodes, iteration indices, command or library call IDs, and free text. Certain markers (e.g., markers indicating the major execution phase of the application) may be inserted into the DS instruction field (field 216 in FIG. 2), whereas phase-specific markers (e.g., sub-phase sequence numbers or iteration count numbers) may be inserted into the DS flags field (e.g., field 218 in FIG. 2). Instructions 528 may be part of a device driver, a PCIe logic, an instrumented library call, or instrumentation codes embedded in the application.

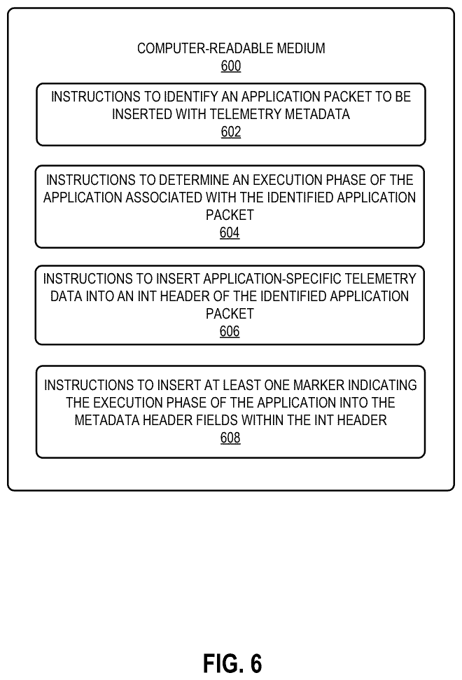

FIG. 6 illustrates a computer-readable medium 600 which facilitates INT-based application instrumentation, according to one aspect of the instant application. CRM 600 may be a non-transitory computer-readable medium or device storing instructions that when executed by a computer or processor cause the computer or processor to perform a method.

CRM 600 may store instructions 602 to identify an application packet to be inserted with INT telemetry metadata, instructions 604 to determine an execution phase of the application associated with the identified application packet, instructions 606 to insert application-specific telemetry data into a header of the identified application packet, instructions 608 to insert at least one marker indicating the execution phase of the application into the INT metadata header fields within the header. CRM 600 may include more instructions than those shown in FIG. 6. For example, CRM 600 may also include instructions to insert a profile ID, which may specify a set of CSR values to be collected as telemetry metadata, into the DS instruction or flags field.

In general, the disclosure solves the technical problem of linking network telemetry data with the execution stages of an application. The disclosed system may apply INT techniques to gather and report application-specific telemetry data during application runtime without adversely impacting performance. When application data packets traverse a network, each node (e.g., a switch, a router, or a network interface card (NIC)) may insert telemetry metadata (e.g., congestion metrics, per-hop latency, buffer utilization, etc.) into the INT header of the packets. When a packet arrives at the destination, the INT header can be extracted, and a report can be created and written to a local management buffer to allow the user to see a trace of the network behavior over the application's runtime. To correlate the telemetry data inserted into a packet with the execution phase of an application, additional application execution context (e.g., in the form of markers) may be inserted into the metadata header fields (e.g., the DS instruction field and/or the DS flags field) at the sender node to mark the execution progress of the application. Such markers may be inserted as a default operation, by a device driver, by a Peripheral Component Interconnect Express (PCIe) logic recognizing virtual machine identifiers or virtual function identifiers, by match-action logics, by instrumented library calls, or by instrumentation codes embedded in the application codes.

One aspect of the disclosure can provide a method and system for application instrumentation. During operation, a node within a network may identify an application packet to be inserted with telemetry metadata, determine an execution phase of an application associated with the identified application packet, and insert application-specific telemetry metadata into an In-band Network Telemetry (INT) header of the identified application packet, the INT header comprising one or more metadata header fields and one or more metadata fields. The node may further insert at least one marker into the one or more metadata header fields, the marker indicating the determined execution phase of the application.

In a variation on this aspect, the metadata header fields may include a domain-specific instruction field and a domain-specific flags field.

In a further variation, the node may select a profile identifier from a plurality of profile identifiers corresponding to a plurality of network-information collecting profiles, a respective network-information collecting profile specifying types of network information to be collected at subsequent hops in the network. The node may insert the selected profile identifier into the domain-specific instruction field or the domain-specific flag field.

In a further variation, selecting the profile identifier may include performing a match-action lookup based on header information included in the identified application packet, and a result of the match-action lookup may specify the profile identifier and the at least one marker.

In a variation on this aspect, subsequent hops in the network may collect telemetry metadata, insert the telemetry metadata into the metadata fields, and associate the telemetry metadata with the execution phase of the application based on the inserted at least one marker.

In a variation on this aspect, the at least one marker may be inserted by a device driver or a PCIe logic executing on the sender node.

In a variation on this aspect, the at least one marker may be inserted by an instrumented library call.

In a variation on this aspect, the at least one marker may be inserted by instrumentation codes embedded in the application.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A computer-implemented method, comprising:
identifying, by a node within a network, an application packet to be inserted with telemetry metadata;
determining an execution phase of an application associated with the identified application packet;
inserting, by the node, application-specific telemetry metadata into an In-band Network Telemetry (INT) header of the identified application packet, the INT header comprising one or more metadata header fields and one or more metadata fields; and
inserting at least one marker into the one or more metadata header fields, the marker indicating the determined execution phase of the application.

2. The computer-implemented method of claim 1, wherein the metadata header fields comprise a domain-specific instruction field and a domain-specific flags field.

3. The computer-implemented method of claim 2, further comprising:
selecting a profile identifier from a plurality of profile identifiers corresponding to a plurality of network-information collecting profiles, a respective network-information collecting profile specifying types of network information to be collected at subsequent hops in the network; and
inserting the selected profile identifier into the domain-specific instruction field.

4. The computer-implemented method of claim 3, wherein selecting the profile identifier comprises performing a match-action lookup based on header information included in the identified application packet, and wherein a result of the match-action lookup specifies the profile identifier and the at least one marker.

5. The computer-implemented method of claim 1, further comprising:
collecting, by subsequent hops in the network, telemetry metadata;
inserting the telemetry metadata into the metadata fields; and
associating the telemetry metadata with the execution phase of the application based on the inserted at least one marker.

6. The computer-implemented method of claim 1, wherein the at least one marker is inserted by a device driver or a PCIe logic executing on the sender node.

7. The computer-implemented method of claim 1, wherein the at least one marker is inserted by an instrumented library call.

8. The computer-implemented method of claim 1, wherein the at least one marker is inserted by instrumentation codes embedded in the application.

9. A node within a network, comprising:
a processing resource; and
a non-transitory machine-readable storage medium comprising instructions executable by the processing resource to:
identify an application packet to be inserted with telemetry metadata;
determine an execution phase of an application associated with the application packet;
insert application-specific telemetry metadata into an In-band Network Telemetry (INT) header of the identified application packet, the INT header comprising one or more metadata header fields and one or more metadata fields; and
insert at least one marker into the one or more metadata header fields, the marker indicating the determined execution phase of the application.

10. The node of claim 9, wherein the metadata header fields comprise a domain-specific instruction field and a domain-specific flag field.

11. The node of claim 10, wherein the processing resource is to:
selecting a profile identifier from a plurality of profile identifiers corresponding to a plurality of network-information collecting profiles, a respective network-information collecting profile specifying types of network information to be collected at subsequent hops in the network; and
insert the selected profile identifier into the domain-specific instruction field.

12. The node of claim 11, wherein selecting the profile identifier comprises performing a match-action lookup based on header information included in the identified application packet, and wherein a result of the match-action lookup specifies the profile identifier and the at least one marker inserted into the domain-specific instruction field or the domain-specific flag field.

13. The node of claim 9, the instructions further to:
collect, by subsequent hops in the network, telemetry metadata;
insert the telemetry metadata into the metadata fields; and
associate the telemetry metadata with the execution phase of the application based on the inserted at least one marker.

14. The node of claim 9, wherein the instructions comprise a device driver or a PCIe logic executable by the processing resource to insert the at least one marker into the INT header fields.

15. The node of claim 9, wherein the instructions comprise an instrumented library call executable by the processing resource to insert the at least one marker inserted into the metadata header fields.

16. The node of claim 9, wherein the instructions comprise instrumentation codes embedded in the application executable by the processing resource to insert the at least one marker into the metadata header fields.

17. A non-transitory machine-readable storage medium storing instructions executable by a processing resource to:
identify, by a node within a network, an application packet to be inserted with telemetry metadata;
determine an execution phase of an application associated with the application packet;
insert application-specific telemetry metadata into an In-band Network Telemetry (INT) header of the identified application packet, the INT header comprising one or more metadata header fields and one or more metadata fields; and
insert at least one marker into the one or more metadata header fields, the marker indicating the determined execution phase of the application.

18. The non-transitory machine-readable storage medium of claim 17, the instructions further to:
selecting a profile identifier from a plurality of profile identifiers corresponding to a plurality of network-information collecting profiles, a respective network-information collecting profile specifying types of network information to be collected at subsequent hops in the network; and
insert the selected profile identifier into the metadata header fields.

19. The non-transitory machine-readable storage medium of claim 17, the instructions further to:
perform a match-action lookup based on header information included in the identified packet, a result of the match-action lookup specifying the profile identifier and the at least one marker.

20. The non-transitory machine-readable storage medium of claim 17, the instructions to insert the at least one marker into the INT header fields comprise:
a device driver;
a PCIe logic;
an instrumented library call; or
instrumentation codes embedded in the application.
